(19) United States
(12) Patent Application Publication
(10) Pub. No.: US 2014/0087649 A1
(43) Pub. Date: Mar. 27, 2014

(54) Cleanroom and Cleaning Apparatus

(71) Applicant: Shenzhen China Star Optoelectronics Technology Co. Ltd., Shenzhen, Guangdong (CN)

(72) Inventors: Yunshao Jiang, Shenzhen City (CN); Chunhao Wu, Shenzhen City (CN); Kunhsien Lin, Shenzhen City (CN); Yongqiang Wang, Shenzhen City (CN); Zhiyou Shu, Shenzhen City (CN); Zhenhua Guo, Shenzhen City (CN)

(21) Appl. No.: 13/642,542

(22) PCT Filed: Oct. 8, 2012
(86) PCT No.: PCT/CN12/82549

§ 371 Date: Oct. 21, 2012

(30) Foreign Application Priority Data
Sep. 26, 2012 (CN) 201210364869.5

(51) Int. Cl. H05F 1/00; F24F 3/16

(52) U.S. Cl. CPC H05F 1/00; F24F 3/161
USPC 454/187; 55/385.2

(57) ABSTRACT

The present invention discloses a cleanroom for storing glass substrates. The cleanroom includes an outlet disposed on a bottom of the cleanroom. A cleaning unit is arranged on a ceiling of the cleanroom and which provides a cleaned, ionized air flow so as to eliminate a static electricity and airborne particles accumulated over a surface of a glass substrate. In addition, the present invention further provides a cleaning unit. An ionized airflow is generated so as to remove the airborne particles and static electricity accumulated over the glass substrate. It features an excellent performance, and therefore increases the yield of the product.

### FIELD OF THE INVENTION

The present invention relates to a technology of manufacturing of liquid crystal display device, and more particularly, to a cleanroom and a cleaning apparatus incorporated to the cleanroom.

### DESCRIPTION OF PRIOR ART

Cleanroom is also referred to as dust-free room remained with a low level of environmental pollutants, such as dust, airborne microbes, aerosol particles and chemical vapors. More accurately, a cleanroom has a controlled level of contamination that is specified by the number of particles per cubic meter at a specified particle size. In the field of manufacturing a high tech product, such as a glass substrate used to make liquid crystal display device, the cleanness, temperature and humidity of the environment have to be controlled to within a controlled range so as to ensure the glass substrate manufactured therefrom meet the preset requirements.

In the existing cleanroom, an inlet with a filter is arranged on a ceiling of the cleanroom so as to provide cleaning air to the cleanroom, while an outlet is used to drain out the air or polluted air, including airborne particles from the cleanroom.

However, static electricity can readily be generated resulted from all kinds of frictions, conductance etc, and the airborne dust and particles can readily stick to certain surface because of the static electricity and because of that, the dust cluster is very difficult to remove. In addition, the static electricity can also cause a permanent damage to IC and ITO as it can create an electrical shock penetrating those elements.

### SUMMARY OF THE INVENTION

It is an object of the present invention to provide a cleanroom and a cleaning apparatus incorporated therewith so as to effectively eliminate the static electricity generated within the cleanroom.

In order to resolve the issues encountered by the prior art, the present invention provides a technical solution by introducing a cleanroom for storing glass substrates. The cleanroom includes:

An outlet which is disposed on a bottom of the cleanroom.

A cleaning unit is arranged on a ceiling of the cleanroom and which provides a cleaned, ionized air flow so as to eliminate a static electricity and airborne particles accumulated over a surface of a glass substrate.

Wherein the cleaning unit includes a blower, a filtering device, and negative ion purifier so as to provide ionized airflow after the air is drawn in through the blower, filtered with the filtering device, and eventually ionized by the negative ion purifier.

In order to resolve the issues encountered by the prior art, the present invention provides a technical solution by introducing a cleanroom for storing glass substrates. The cleanroom includes:

An outlet which is disposed on a bottom of the cleanroom.

A cleaning unit is arranged on a ceiling of the cleanroom and which provides a cleaned, ionized air flow so as to eliminate a static electricity and airborne particles accumulated over a surface of a glass substrate.

According to a preferred embodiment, wherein the cleaning unit includes a blower, a filtering device, and negative ion purifier so as to provide ionized airflow after the air is drawn in through the blower, filtered with the filtering device, and eventually ionized by the negative ion purifier.

According to a preferred embodiment, wherein the filtering device includes a preliminary filter, a high-performance filter, and a super-high-performance filter.

According to a preferred embodiment, wherein the cleanroom includes a top ceiling, sidewalls, and a bottom floor and the cleaning unit is arranged on top of the top ceiling.

According to a preferred embodiment, wherein the cleanroom includes a plurality of towers disposed on the bottom floor and each is used to store a plurality of trays in which the glass substrates are disposed therein.

According to a preferred embodiment, wherein the cleanroom includes a guide rail system arranged on the bottom floor.

According to a preferred embodiment, wherein the cleanroom is incorporated with an automatic transporting apparatus moving all kinds of equipment through the guide rail system, and the automatic transporting apparatus includes a lift-fork retrieving and disposing the tray to and from the towers.

According to a preferred embodiment, wherein the cleanroom includes a blower disposed on the bottom floor of the cleanroom, a vertex within the cleanroom can be readily reduced by creating a vertical airflow between the cleaning unit and the blower.

According to a preferred embodiment, wherein the guide rail system has a pair of rails dividing the bottom floor into an internal zone and an external zone, wherein the blower is arranged within the internal zone.

According to a preferred embodiment, wherein the guide rail system has a pair of rails dividing the bottom floor into an internal zone and an external zone, wherein the blower is arranged within the external zone.

According to a preferred embodiment, wherein the guide rail system has a pair of rails dividing the bottom floor into an internal zone and an external zone, wherein the blower is arranged in both the internal zone and the external zone.

In order to resolve the issues encountered by the prior art, the present invention provides a technical solution by introducing a cleaning apparatus includes a cleaning unit providing a cleaned, ionized air flow so as to eliminate a static electricity and airborne particles accumulated over a surface of a glass substrate. The cleaning unit includes a blower, a filtering device, and negative ion purifier so as to provide ionized airflow after the air is drawn in through the blower, filtered with the filtering device, and eventually ionized by the negative ion cleaner.

The present invention can be concluded with the following advantages. As compared to the existing prior art, the cleanroom made in accordance with the present invention provides a measurement to eliminate the static electricity. An ionized airflow is generated so as to remove the airborne particles and static electricity accumulated over the glass substrate. It features an excellent performance, and therefore increases the yield of the product.

### BRIEF DESCRIPTION OF DRAWINGS

In order to give a better and thorough understanding to the whole and other intended purposes, features and advantages of the technical solution of the present invention, detailed description will be given with respect to preferred embodiments provided and illustrated herebelow in accompanied drawings. Apparently, with the spirit of the embodiments disclosed, person in the skilled in the art can readily come out with other modifications as well as improvements without undue experiment. In addition, other drawings can be readily achieved based on the disclosed drawings. Wherein

FIG. 1 is an illustrational and perspective view of a cleanroom made in accordance with a preferred embodiment of the present invention;

FIG. 2 is an illustrational sectional view of the cleanroom made in accordance with a preferred embodiment of the present invention;

FIG. 3 is similar to FIG. 2, and is an illustrational sectional view of the cleanroom made in accordance with a preferred embodiment of the present invention;

FIG. 4 is an illustrational and perspective view of a cleaning unit made in accordance with a preferred embodiment of the present invention; and

FIG. 5 is an illustrational and cross sectional view of a cleanroom made in accordance with another preferred embodiment of the present invention viewing from atop.

### DETAILED DESCRIPTION OF PREFERRED EMBODIMENT

In order clearly explain the technology of the embodiment illustrated in the present invention, a brief and concise description will be given along with the accompanied drawings. Apparently, the embodiments illustrated in the drawings are merely some typical embodiments and which can be readily modified by the skilled in the art without any additional laborious efforts so as to transform them into other drawings, and they should all be covered by the appended claims.

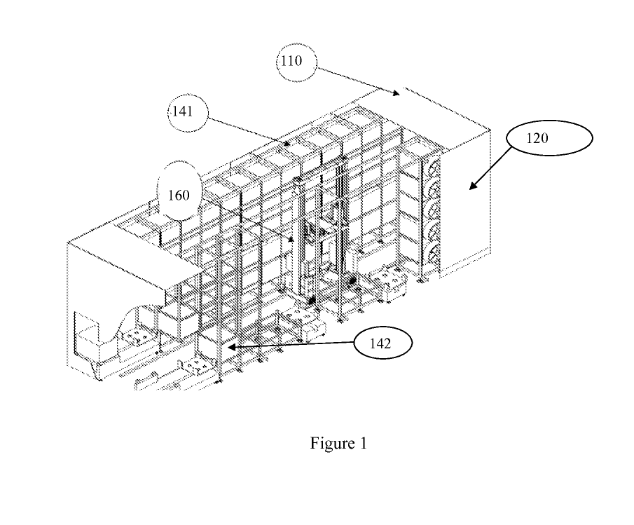

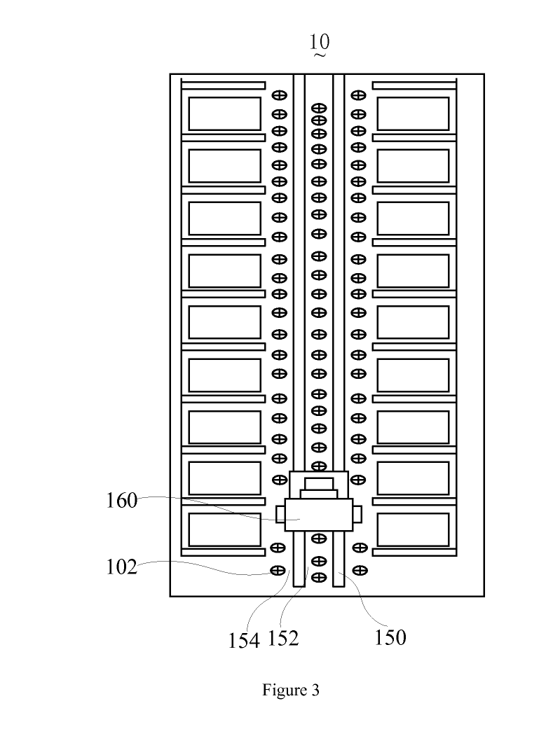

Referring to FIGS. 1 to 3, a cleanroom 10 is provided for storing glass substrates. The cleanroom 10 includes an outlet 102 and a cleaning unit 200.

The outlet 102 is arranged on a bottom floor of the cleanroom 10, and the cleaning unit 200 is arranged on a top ceiling of the cleanroom 10. The cleaning unit 200 supplies a cleaned, ionized airflow to the cleanroom 10 so as to remove airborne particles within the cleanroom 10 and dust, particles accumulated over a surface of the glass substrate.

Substantially, the cleanroom 10 made in accordance with the present invention includes a top ceiling 110, a sidewall 120, and a bottom floor 130 which jointly define internal space of the cleanroom 10. The cleanroom 10 further includes a plurality of towers 140, a guide rail system 150, and an automatic transporting apparatus 160, and the cleaning unit 200.β

The top ceiling 110 is configured with a plurality of unit boards, and a plurality of vents or inlets are defined in the top ceiling 110. The cleaning unit 200 is arranged with respect to the vents so as to supply the cleaned, ionized airflow into the cleanroom 10 through the vents.

There is totally four sidewalls 120, together with the top ceiling 110 and the bottom floor 130, the cleanroom 10 with a substantially rectangular space is defined. In addition, the sidewall 120 can also be configured with plurality of unit walls.

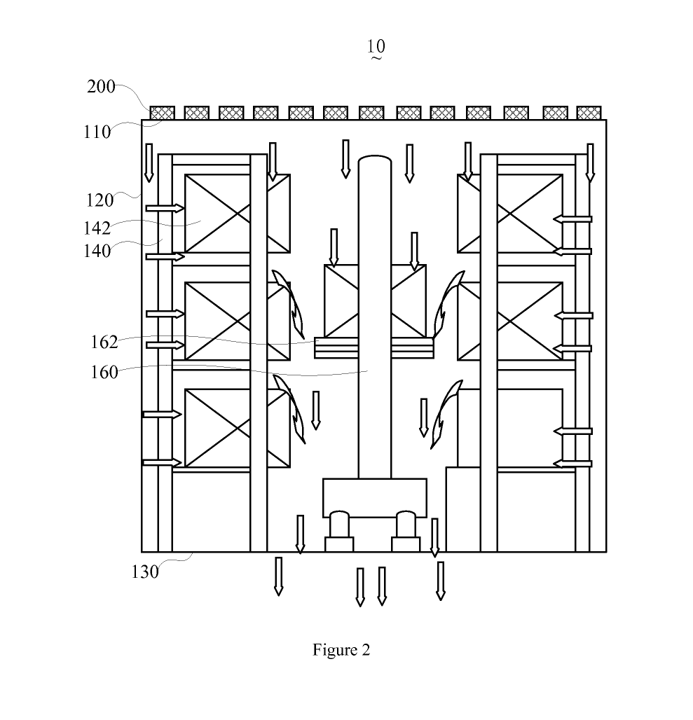

The bottom floor 130 is high-rise floor above the ground. The bottom floor 130 can also be configured with a plurality of unit floors. The bottom floor 130 is defined with a plurality of outlets 102. As shown in FIG. 2, the bottom floor 130 is defined with three outlets 102 at a central region thereof. Of course, the arrangement of the outlets 102 is limited to what disclosed and illustrated in FIG. 2.

The towers 140 are arranged onto the bottom floor 130. Each of the towers 140 is defined with a plurality storing cells 141 in which tray 142 can be disposed therein. The tray 142 is used to store glass substrates. As shown in FIGS. 1 and 2, the cleanroom 10 is provided with two towers 140 which are configured with a plurality of unit shelves.

The guide rail system 150 is arranged onto the bottom floor 130 and it configures with two rails. The rails 150 divide the bottom floor 130 into internal zone 152, and external zone 154. In the preferred embodiment, the rails 150 are arranged between the towers 140.

The automatic transporting apparatus 160 is moveably disposed onto the guide rail system 150. The automatic transporting apparatus 160 includes a lift-fork 162 which is used to dispose the tray 142 into the cell or to retrieve the tray from the cell of the towers 140.

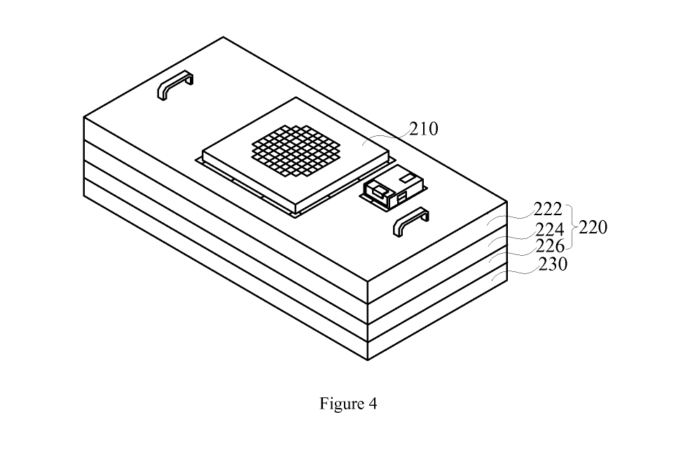

Referring to FIG. 4, which is an illustrational and perspective view of a cleaning unit made in accordance with a preferred embodiment of the present invention.

As shown in FIG. 4, the cleaning unit 200 is configured with a blower 210, a filtering device 220, and a negative ion purifier 230.

Wherein the blower 210 draws in the air, and filtering it with the filtering device 220, eventually, the ionized airflow is coming out of the negative ion purifier 230 and directed into the cleanroom 10.

Substantially, the filtering device 220 includes a preliminary filter 222, a high-performance filter 224, and a super-high-performance filter 226. The high-performance filter 224 can effectively remove the airborne particles with a diameter of 0.3 μm up to 99.97%, which is about one two hundredth of human hair. This high-performance filter 224 can effectively remove the smoke, dust, and even airborne fungus. The super-high-performance filter 226 can effectively remove the smoke, dust, and fungus with a dimension of 0.1˜0.2 μm. Its performance can reach up to 99.97%.

Not only can the negative ion purifier 230 be used to filter the air, but also can it supply ionized airflow. Once those ions are distributed over the tray, and eventually over the surface of the glass substrate, the static electricity accumulated on the glass substrate can be effectively removed. The ionized airflow carries negative charges, which will neutralize the positive charges carried by the dust and smoke. As a result, the neutralized particles will quickly become a cluster and lower down. With the neutralization of negative and positive charges, the air within the cleanroom is purified.

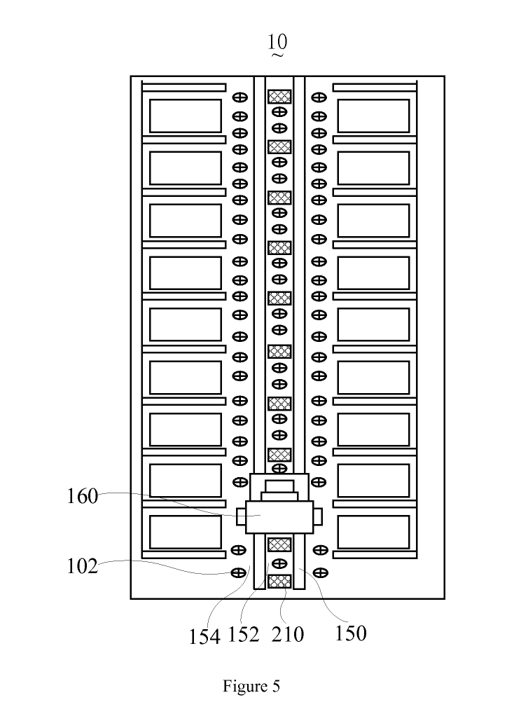

Referring to FIG. 5, is an illustrational and cross sectional view of a cleanroom made in accordance with another preferred embodiment of the present invention viewing from atop.

As shown in FIG. 5, in this embodiment, the cleanroom 10 includes a blower 210 which is arranged on a bottom floor of the cleanroom 10. When the blower 200 is arranged on the bottom floor, it can create a substantially vertical flow between the cleaning unit 200 so as to prevent any vertex created within the cleanroom 10. A steady airflow within the cleanroom 10 can effectively prevent the dust or any airborne particles be stirred up and eventually contaminate the glass substrate. As a result, the yield can be raised.

Even the blower 210 is arranged to the outlet 102, it can be readily understood that the number of the blower 210 can be lower than the number of the outlet 102. In general, the blower 210 mounted on the bottom floor 130 is directly corresponding to a cleaning unit 200 mounted onto the top ceiling 110. With this substantial in-line arrangement, vertical airflow can be readily created.

In the preferred embodiment, the blower 210 is arranged within the internal zone 152 of the guide rail system 150. By this arrangement, the blower 210 is substantially arranged between the towers 140. This is an ideal location to arrange the blower 210 as the internal zone 152 can be fully utilized as the precious estate of the cleanroom 10 can be used for other equipment. Of course, in other embodiments, the blower 210 can be arranged at external zone 54, or alternatively, the blowers 210 can be arranged both in the internal zone 152 and the external zone 154.

The present invention can be concluded with the following advantages. As compared to the existing prior art, the cleanroom made in accordance with the present invention provides a measurement to eliminate the static electricity. An ionized airflow is generated so as to remove the airborne particles and static electricity accumulated over the glass substrate. It features an excellent performance, and therefore increases the yield of the product.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

1. A cleanroom for storing glass substrates, comprising
an outlet disposed on a bottom of the cleanroom
a cleaning unit arranged on a ceiling of the cleanroom and which provides a cleaned, ionized air flow so as to eliminate a static electricity and airborne particles accumulated over a surface of a glass substrate; and
wherein the cleaning unit includes a blower, a filtering device, and negative ion purifier so as to provide ionized airflow after the air is drawn in through the blower, filtered with the filtering device, and eventually ionized by the negative ion purifier.

2. A cleanroom for storing glass substrates, comprising
an outlet disposed on a bottom of the cleanroom; and
a cleaning unit arranged on a ceiling of the cleanroom and which provides a cleaned, ionized air flow so as to eliminate a static electricity and airborne particles accumulated over a surface of a glass substrate.

3. The cleanroom as recited in claim 2, wherein the cleaning unit includes a blower, a filtering device, and negative ion purifier so as to provide ionized airflow after the air is drawn in through the blower, filtered with the filtering device, and eventually ionized by the negative ion cleaner.

4. The cleanroom as recited in claim 3, wherein the filtering device includes a preliminary filter, a high-performance filter, and a super-high-performance filter.

5. The cleanroom as recited in claim 3, wherein the cleanroom includes a top ceiling, sidewalls, and a bottom floor and the cleaning unit is arranged on top of the top ceiling.

6. The cleanroom as recited in claim 5, wherein the cleanroom includes a plurality of towers disposed on the bottom floor and each is used to store a plurality of trays in which the glass substrates are disposed therein.

7. The cleanroom as recited in claim 5, wherein the cleanroom includes a guiderail system arranged on the bottom floor.

8. The cleanroom as recited in claim 5, wherein the cleanroom is incorporated with an automatic transporting apparatus moving all kinds of equipment through the guiderail system, and the automatic transporting apparatus includes a lift-fork retrieving and disposing the tray to and from the towers.

9. The cleanroom as recited in claim 8, wherein the cleanroom includes a blower disposed on the bottom floor of the cleanroom, a vertex within the cleanroom can be readily reduced by creating a vertical airflow between the cleaning unit and the blower.

10. The cleanroom as recited in claim 9, wherein the guide rail system has a pair of rails dividing the bottom floor into an internal zone and an external zone, wherein the blower is arranged within the internal zone.

11. The cleanroom as recited in claim 9, wherein the guide rail system has a pair of rails dividing the bottom floor into an internal zone and an external zone, wherein the blower is arranged within the external zone.

12. The cleanroom as recited in claim 9, wherein the guide rail system has a pair of rails dividing the bottom floor into an internal zone and an external zone, wherein the blower is arranged in both the internal zone and external zone.

13. A cleaning unit providing a cleaned, ionized air flow so as to eliminate a static electricity and airborne particles accumulated over a surface of a glass substrate, wherein the cleaning unit includes a blower, a filtering device, and negative ion purifier so as to provide ionized airflow after the air is drawn in through the blower, filtered with the filtering device, and eventually ionized by the negative ion purifier.

14. The cleaning unit as recited in claim 13, wherein the cleaning unit includes a blower, a filtering device, and negative ion purifier so as to provide ionized airflow after the air is drawn in through the blower, filtered with the filtering device, and eventually ionized by the negative ion cleaner

15. The cleaning unit as recited in claim 14, wherein the filtering device includes a preliminary filter, a high-performance filter, and a super-high-performance filter.
